(19) United States
(12) Patent Application Publication
(10) Pub. No.: US 2011/0000943 A1
(43) Pub. Date: Jan. 6, 2011

(54) Traffic cone carrier unit for a motor vehicle

(76) Inventor: Shaun Leslie Krebsbach, St. Paul, MN (US)

Correspondence Address: PAUL R. MARTIN, 5333 BAYRIDGE COURT, FAIRFIELD, CA, 94534, US

(21) Appl. No.: 12/383,612

(22) Filed: Mar. 30, 2009

(51) Int. Cl. B60R 11/00; B23P 17/04

(52) U.S. Cl. 224/512; 29/428

(57) ABSTRACT

A traffic cone storage unit is movably mounted on a rear portion of a motor vehicle to store traffic cones thereon. The unit includes a mounting frame attached to the undersurface of a motor vehicle adjacent to the rear of that vehicle and a stanchion pivotally mounted on that mounting frame to move between a first orientation that is upright with respect to a surface on which the motor vehicle is resting and a second orientation that is horizontal with respect to the surface on which the motor vehicle is resting. Traffic cones are stored on the stanchion when it is in the first orientation and the stanchion is out of the way when it is in the second orientation so that access can be made to the interior of the motor vehicle even when the traffic cone storage unit is in place on the motor vehicle. A chain or like tether element can be used to attach the top of the stanchion to the motor vehicle to further ensure stability thereof.

### TECHNICAL FIELD OF THE INVENTION

The present invention relates to the general art of motor vehicles, and to the particular field of motor vehicle accessories adapted to carry traffic cones.

### BACKGROUND OF THE INVENTION

Traffic markers, called traffic cones, are well known and have been in use for many years. Traffic cones usually have a flat square base and an elongated cone extending vertically therefrom. The vertically extending cone is usually of brightly colored fluorescent material. These traffic cones are often used to direct traffic away from a work area or away from an accident area, or the like.

As is also known, it is frequently necessary for the truck and service vehicles used in highway and utility construction and maintenance, to operate and park along the margins of busy highways and streets. This exposes the vehicle and crew to serious hazard of accidents.

It is conventional practice to surround the vehicle with safety signals of various types, and in particular with safety signal cones of brightly colored fluorescent material. In some instances the cones are mounted directly on the vehicle.

Traffic cones have been carried in the past on service vehicles, such as utility trucks, telephone trucks, etc., loosely stacked in the back of the vehicle. Traffic cones are usually transported in a nesting position stacked and loaded into the cargo space of a vehicle or nestled in boxes or loading compartments. The means known to the inventor for carrying traffic cones on a vehicle have several drawbacks. For example, the known means may be cumbersome to use. More importantly, however, the means known to the inventor often get in the way of other cargo being carried or interfere with the placement or removal of such cargo on the vehicle.

Therefore, there is a need for a suitable support for carrying traffic cones in a stacked relation.

There is a further need for a means for carrying traffic cones on a vehicle in a manner which maintains the stored cones out of the way and allows convenient access to the cargo area.

### SUMMARY OF THE INVENTION

The above-discussed disadvantages of the prior art are overcome by a traffic cone storage unit that is movably mounted on a rear portion of a motor vehicle to store traffic cones thereon. The unit includes a mounting frame attached to the undersurface of a motor vehicle adjacent to the rear of that vehicle and a stanchion pivotally mounted on that mounting frame to move between a first orientation that is upright with respect to a surface on which the motor vehicle is resting and a second orientation that is horizontal with respect to the surface on which the motor vehicle is resting. Traffic cones are stored on the stanchion when it is in the first orientation and the stanchion is out of the way when it is in the second orientation so that access can be made to the interior of the motor vehicle even when the traffic cone storage unit is in place on the motor vehicle. A chain or like tether element can be used to attach the top of the stanchion to the motor vehicle to further ensure stability thereof.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a side elevational view of a motor vehicle having a mounting frame portion of the cone storage unit of the present invention mounted thereon.

FIG. 2 is a perspective view of a cone storage unit embodying the principles of the present invention.

### DETAILED DESCRIPTION OF THE INVENTION

Referring to the figures, it can be understood that the present invention is embodied in a traffic cone storage unit 10 that is used in conjunction with a motor vehicle, such as a truck 20, to store traffic cones thereon in a manner which allows the cones to be stored in a convenient location, such as adjacent to the rear end 22 of the motor vehicle, yet to not interfere with access to or from the motor vehicle, such as via a rear door 24 of the vehicle.

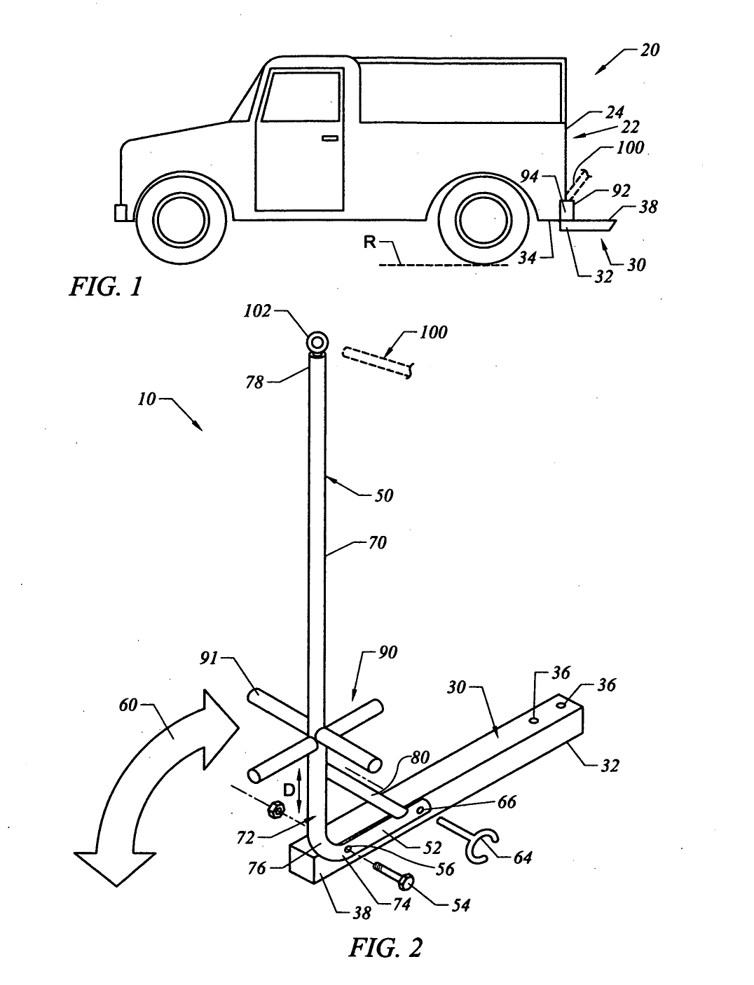

Unit 10 includes a mounting frame 30 that is fixed at proximal end 32 thereof to an undersurface 34 of the motor vehicle adjacent to the rear end 22 of that vehicle so the mounting frame extends rearwardly away from the vehicle as can be understood from FIG. 1. Suitable fasteners, such as bolts or the like extend through fastener-accommodating holes, such as hole 36 defined through proximal end 32 to associated fastener-accommodating openings defined in the motor vehicle. A distal end 38 of the mounting frame is thus spaced apart from the vehicle.

An L-shaped stanchion 50 is mounted on the mounting frame adjacent to distal end 38 thereof. Stanchion 50 includes a first leg 52 which is pivotally attached to mounting frame 30 by a pivot pin 54 extending through pivot pin accommodating hole 56 defined through leg 52 and into a corresponding pivot pin accommodating hole defined in mounting frame 30 so the stanchion can move between a first orientation which is upright with respect to a supporting surface such as a roadway R on which the motor vehicle is located and a second orientation which is horizontal with respect to the supporting surface. Movement of the stanchion about a pivot defined by pivot pin 54 extending through first leg 52 and into the hole defined in frame 30 is indicated in FIG. 2 by double-headed arrow 60. A set pin 64 extends through a set pin accommodating hole 66 defined through first leg 52 and is removably received in a corresponding set pin accommodating hole defined in the mounting frame to lock the stanchion in the first orientation thereof. For purposes of illustration, the stanchion is oriented in the first orientation thereof in FIG. 2.

Stanchion 50 is one piece and includes a second leg 70 which is one piece with the first leg and which includes a proximal end 72 which is one piece with end 74 of the first leg via an elbow joint 76 and which further includes a distal end 78 that is spaced apart from the mounting frame. A strut 80 connects the first and second legs of the stanchion together near elbow joint 76 and adds strength to the stanchion.

A cruciform shaped cone seat 90 is mounted on second leg 70 of stanchion 50 and supports traffic cones thereon as will be understood by those skilled in the art based on the teaching of this disclosure. Seat 90 includes four legs, such as leg 91, which extend radially outward from second leg 70 so seat 90 is sized to securely support traffic cones thereon via the base of such cones and is spaced from mounting frame 30 a distance D which is sufficient to locate seat 90 above top surface 92 of rear bumper 94 of the motor vehicle when the stanchion is in the first orientation thereof whereby traffic cones supported on seat 90 are located above the rear bumper when the stanchion is in the first orientation thereof. However, as can be understood from the teaching of this disclosure, when stanchion 50 is in the second orientation thereof, it will be located out of the way of the rear section of the motor vehicle whereby access to or from an access area of the motor vehicle, such as the rear of the motor vehicle, is not impeded by the stanchion or any traffic cones stored thereof. As will be understood by those skilled in the art based on the teaching of this disclosure, unit 10 could be located at other areas on the motor vehicle, and the disclosure of the unit being located adjacent to the rear of the vehicle is intended as illustrative of the best mode and is not intended as limiting.

Further stability can be added to traffic cone storage unit 10 by attaching distal end 78 of stanchion 50 to the rear bumper of the motor vehicle by a chain 100 attached at one end thereof to a chain locking ring 102 fixedly mounted on stanchion 50 at distal end 78 and attached at the other end thereof to the motor vehicle rear bumper as indicated in FIGS. 1.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A traffic cone storage unit comprising:
A) a stanchion on which traffic cones are stored;
B) a pivot connection pivotally connecting the stanchion to a motor vehicle to move between a first orientation which is upright with respect to a surface on which the motor vehicle is located and a second orientation which is horizontal with respect to the surface on which the motor vehicle is located; and
C) a set pin which is removably mounted on the stanchion and which holds the stanchion in the first orientation when in place and which is removed from the stanchion when the stanchion is moved from the first orientation thereof to the second orientation thereof.

2. The traffic cone storage unit defined in claim 1 further including a mounting frame attaching the stanchion to the motor vehicle.

3. The traffic cone storage unit defined in claim 2 further including a traffic cone seat on the stanchion.

4. The traffic cone storage unit defined in claim 3 wherein the traffic cone seat is spaced apart from the mounting frame a distance sufficient to locate the traffic cone seat above a top surface of a rear bumper of the motor vehicle when the stanchion is in the first orientation thereof.

5. The traffic cone storage unit defined in claim 4 wherein the stanchion is L-shaped and has a first leg that is one piece with a second leg.

6. The traffic cone storage unit defined in claim 5 further including a strut on the stanchion connecting the first leg of the stanchion to the second leg of the stanchion.

7. The traffic cone storage unit defined in claim 6 wherein the first leg of the stanchion is connected to the mounting frame by the pivot connection.

8. The traffic cone storage unit defined in claim 7 wherein the stanchion has a distal end that is spaced apart from the pivot connection and further includes a chain locking ring mounted on the distal end of the stanchion.

9. The traffic cone storage unit defined in claim 8 further including a chain connected at one end thereof to the chain locking ring on the distal end of the stanchion and at a second end to the motor vehicle when the chain is in use.

10. The traffic cone storage unit defined in claim 9 wherein the traffic cone seat is cruciform shaped.

11. A method of mounting traffic cones on a motor vehicle comprising steps of:
A) positioning a traffic cone storage unit adjacent to a rear end of a motor vehicle;
B) orienting the traffic cone storage unit into a first orientation which is upright and to extend adjacent to the rear end of the motor vehicle to interfere with access to and from the motor vehicle via the rear end of the motor vehicle;
C) storing traffic cones on the traffic cone storage unit; and
D) moving the traffic cone storage unit into a second orientation which is horizontal and extends away from the rear end of the motor vehicle and permitting access to and from the motor vehicle.

12. A method of mounting traffic cones on a motor vehicle comprising steps of
A) positioning a traffic cone storage unit adjacent to an access area of a motor vehicle;
B) orienting the traffic cone storage unit into a first orientation which extends into a location which interferes with access to or from the access area of the motor vehicle;
C) storing traffic cones on the traffic cone storage unit; and
D) moving the traffic cone storage unit into a second orientation which permits essentially unimpeded access to and from the motor vehicle.
